(19) United States
(12) Patent Application Publication
(10) Pub. No.: US 2017/0366957 A1
(43) Pub. Date: Dec. 21, 2017

(54) WI-FI AWARE PROTECTION SYSTEM

(71) Applicant: Intel IP Corporation, Santa Clara, CA (US)

(72) Inventors: Elad Oren, Tel Aviv (IL); Andrei Otcheretianski, Jerusalem (IL); Emily H. Qi, Camas, WA (US); Po-Kai Huang, Santa Clara, CA (US)

(21) Appl. No.: 15/610,294

(22) Filed: May 31, 2017

Related U.S. Application Data
(60) Provisional application No. 62/350,529, filed on Jun. 15, 2016.

(51) Int. Cl. H04W 8/00; H04W 40/24; H04W 28/12; H04W 84/12; H04W 4/00

(52) U.S. Cl. CPC H04W 8/005; H04W 40/24; H04W 28/12; H04W 4/008; H04W 84/12

(57) ABSTRACT

This disclosure describes systems, methods, and devices for a Wi-Fi Aware protection mechanism system that may determine a Neighbor Awareness Networking management frame with channel protection information, including a timestamp, for a communication channel, enable a protection mode to communicate with one or more other client devices in a Neighbor Awareness Networking data cluster, and send, to the one or more other client devices in the Neighbor Awareness Networking data cluster, the Neighbor Awareness Networking management frame with the channel protection information.

### CROSS-REFERENCE TO RELATED APPLICATIONS

This application claims the benefit of U.S. Provisional Application No. 62/350,529 filed Jun. 15, 2016, the disclosure of which is incorporated herein by reference as if set forth in full.

### TECHNICAL FIELD

This disclosure generally relates to systems, methods, and apparatuses for wireless communications and, more particularly, to a protection mechanism for data transmissions communicated between wireless devices.

### BACKGROUND

Wireless devices are becoming widely prevalent, making them suited for location-based services. Wireless devices may benefit from location-based services that may result in an enhanced user experience. Recently, there has been a shift in technology to support direct wireless communications between wireless devices such as through the use of Wi-Fi Aware protocols. Wi-Fi Aware wireless stations utilize high rate data transmissions that may interfere with wireless stations that do not use high-rate data exchange.

### BRIEF DESCRIPTION OF THE DRAWINGS

FIG. 1 depicts a network diagram illustrating an example network environment of an illustrative Wi-Fi Aware protection mechanism system, in accordance with one or more example embodiments of the disclosure.

FIG. 2A depicts an illustrative database table that may be utilized by a Wi-Fi Aware protection mechanism system, in accordance with one or more embodiments of the disclosure.

FIG. 2B depicts an illustrative database table that may be utilized by a Wi-Fi Aware protection mechanism system, in accordance with one or more embodiments of the disclosure.

FIG. 3A depicts a flow diagram of an illustrative process for an illustrative Wi-Fi Aware protection mechanism system, in accordance with one or more embodiments of the disclosure.

FIG. 3B depicts a flow diagram of an illustrative process for an illustrative Wi-Fi Aware protection mechanism system, in accordance with one or more embodiments of the disclosure.

FIG. 4 depicts a functional diagram of an example communication station that may be suitable for use as a user device, in accordance with one or more example embodiments of the disclosure.

FIG. 5 depicts a block diagram of an example machine upon which any of one or more techniques (e.g., methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Example embodiments described herein provide certain systems, methods, and devices for providing channel protection between devices communicating in a Neighbor Awareness Networking version 2 (NAN2) environment.

As Wi-Fi technology increases in both technical complexity and a broadening feature set, a common platform allowing interoperability may be necessary in order to support this increase. Additionally, the Wi-Fi alliance ensures that Wi-Fi products (e.g., user devices) from multiple manufacturers work well together. In addition, the existing Wi-Fi Direct services (WFDS) discovery protocol does not provide information to set up an application service platform (ASP) session via an Access Point (AP) infrastructure. The WFDS specification defines the architecture, protocols and functionality for interoperability of Wi-Fi Direct Services. An ASP session is a software service or library that implements the common functions needed by all applications and services conforming to the WFDS specification. For example, the existing WFDS discovery protocol cannot be used in Bluetooth low energy (BLE) and near field communication (NFC).

In Neighbor Awareness Networking (NAN), wireless devices may communicate with each other without the need for an AP. Without an AP to transmit information that facilitates communication among the wireless devices, however, the wireless devices may not know when they will communicate with another device and with which device they will communicate. Therefore, a device may be required to use power and processing resources to listen for data packets and to determine if those data packets are meant for the device. Instead of a device constantly listening for and receiving data packets without knowing if they are meant for the device, the device may need to be woken up to establish communication with another device.

The existing NAN standard establishes a process for waking up a NAN device for service advertising and finding interesting service in the proximity, but has not established a dedicated data path between NAN devices. For example, a NAN data path (NDP) may be a data connection established between a pair of NAN devices for a service instance. NAN2 enhancements to the NAN standard may include an establishment of a dedicated NDP between NAN2 devices in a NAN Data Cluster (NDC), which may allow for improved management of device resources. The dedicated NDP may be specific to connected NAN2 devices in an NDC, and the NDC may be a collection of NAN data links with a same NAN data cluster base schedule. In addition, because NAN2 devices may communicate in very high throughput environments that may include significant communication traffic, NAN2 devices may benefit from the communication and use of channel protection information to reduce interference, for example. Example embodiments of the present disclosure relate to systems, methods, and devices for Wi-Fi Aware protection that, when a wireless station or device may detect a condition in which data transmissions need protection, the wireless station or device may send a multicast notification in the Discovery Window (DW), NDC schedule slot, or NAN multicast service group (NMSG) to the other peers in its NAN Data Cluster, which may reflect the protection mode in each channel about which the wireless station or device has information. The peer devices then may compare the information in a multicast notification to what each device has in a device database, may update with the most recent information, may use the information to enable/disable the protection mechanism, and may use the information to select a channel and time slot for a NAN2 transmission.

In example embodiments, a NAN2 device may be capable of operating in a NAN2 network and other types of networks, including a NAN network, a WLAN infrastructure, Independent Base Service Set (IBSS), Wi-Fi Direct, Bluetooth, and the like. A NAN2 device may send multicast NAN2 Service Discovery frames directly to other NAN2 devices within range in the same NAN2 Cluster during the Discovery Window. A NAN2 device may also send unicast NAN2 Service Discovery frames directly to any other NAN2 device within range in the same NAN2 Cluster during the Discovery Window.

In one embodiment, multiple devices may discover one another and form a device cluster. The devices may be able to communicate with each other without an AP in a NAN2 network. A NAN2 Cluster may include multiple NAN2 devices that are synchronized to a common discovery window schedule. The discovery window may include the time and channel on which NAN2 devices converge. To facilitate communications between the neighboring devices, the neighboring devices may synchronize with one another to send beacon frames. Synchronization may facilitate secure transmissions between neighboring devices with reduced interference. For example, a NAN2 device may receive communications from other devices in a NAN2 Cluster. When multiple NAN2 devices communicate over a channel at the same time, interference may occur. Therefore, synchronization of NAN2 devices may allow a NAN2 device to receive a communication from a single NAN2 device while deferring any communications from other NAN2 devices in the NAN2 Cluster. The synchronization of NAN2 devices can be referred to as a channel protection mechanism or mode.

In one embodiment, a Wi-Fi Aware protection mechanism system may facilitate synchronization of neighboring devices in a NAN2 network by using time slots and communicating time stamps with transmissions. Neighboring devices in a NAN2 neighborhood may transmit NAN2 data frames to nearby neighboring devices without the use of an AP. Any device with information about a communication within a particular channel may transmit that information to neighboring devices. The NAN2 data frames may include a time stamp to identify when channel protection elements for a channel are applicable.

In one embodiment, a Wi-Fi Aware protection mechanism system may facilitate a device to receive a NAN2 data frame with channel protection information, which may include a time stamp for the protection elements of a particular channel. The device may evaluate the time stamp to determine whether the NAN2 data frame has more recent information than the device already has. If the device determines that the NAN2 data frame has more recent information than is already stored on the device, the device may update its information according to the more recent information in the NAN2 data frame, and may include that updated information in NAN2 transmissions until another update occurs. Recognizing the most recent information about a given channel can allow a NAN device to select the optimal channel and time to send information rather than requiring an AP or master device to facilitate transmissions. The channel protection information may also allow a NAN2 device to enable or disable protection modes on a particular communication channel in order to reduce interference with that communication channel. For example, the enabling and disabling of protection modes may refer to setting one or more values associated with one or more database entries corresponding to a channel. In particular, the setting of values for the channel protection information may correspond to the enabling and disabling of channel protection modes. In one example, the channel protection mode may indicate, based at least in part on the channel protection information, not to transmit in a channel at a particular time, at least until the channel protection information is updated to indicate that transmitting in the channel is appropriate.

In one embodiment, neighboring devices in a NAN2 neighborhood may be continuously changing communication channels, and therefore may be receiving NAN2 data frames with channel protection information. Therefore, neighboring devices may continuously receive NAN2 data frames from different communication channels and may continuously evaluate whether stored information for those channels is updated, and may determine which channels to use and when.

In one embodiment, the channel protection information may include Effective Radiated Power (ERP) or High-Throughput (HT) protections. The information in NAN2 data frames may include attribute fields, attribute control fields, and channel protection information. The attribute fields may identify a type of NAN2 attributes. The attribute control fields may include a Sequence ID that may increment every time a device updates an attribute to indicate how current the information is for the corresponding attribute. The channel protection information may include a Use_Protection field, an HT Protection field, a Non-GreenField field, and a time stamp. The Use_Protection field may provide information regarding protection settings for non-ERP stations. The HT Protection field may indicate a variety of protection levels, such as no protection, Non Member, 20 MHz protection, and mixed mode protection. The Non-GreenField field may indicate whether a non-GreenField device is present in the NAN2 network. The time stamp may indicate, as described above, the time of the detected information in the NAN2 data frame. Based on the channel protection information, a NAN2 device may determine a communication channel to use for transmissions and when, and can broadcast its channel protection information to other NAN2 devices to coordinate transmissions with those NAN2 devices. For example, if the HT Protection field indicates that there are any non-HT devices to interfere with a transmission, and/or if the Use_Protection field indicates that there are any non-ERP stations which could interfere with a transmission, a channel protection mode may be employed based at least in part on the channel protection information to select a communication channel and/or a time for executing data transmissions, or to determine not to transmit in a channel at a given time.

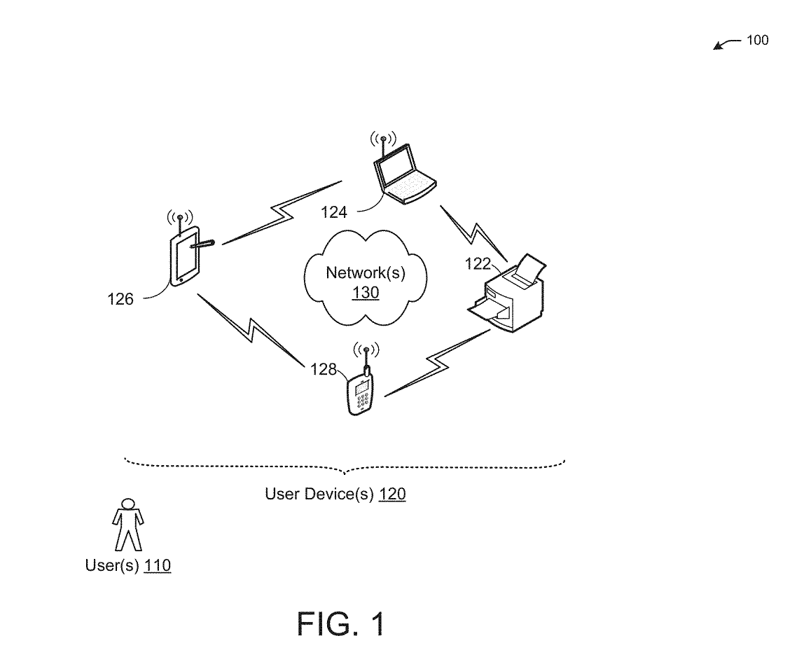

FIG. 1 is a network diagram illustrating an example wireless network 100 of a flexible connectivity framework system, according to some example embodiments of the present disclosure. Wireless network 100 can include one or more user devices 120 (e.g., 122, 124, 126, or 128), which may communicate in accordance with wireless standards, such as the IEEE 802.11 communication standards, over network(s) 130. In one embodiment, the one or more user devices 120 may be utilized by one or more user(s) 110 for wireless communications in accordance with IEEE 802.11 communication standards.

For example, the user devices 120 may be NAN2 devices that may perform connectivity procedures with one another in order to set up a NAN2 data path (NDP). The NDP does not exist in the existing NAN standard. An established NAN data link (NDL) may allow for the exchange of multiple services between different NAN devices. Each service may have different requirements, such as security and address requirements. As a result, specific NDPs may be provided for different services. In one embodiment, the user devices 120 may utilize an NDP negotiation procedure defined to enable data transmission between two NAN2 devices. This negotiation procedure may be an association process (similar to an Access Point-Station (AP-STA) process in a typical Wi-Fi infrastructure. In Wi-Fi, a station which exchanges data (e.g., a transmitting station) with another station (e.g., receiving station), should ensure that a potential interferer would not transmit at the same time and interfere with the data exchange. For this goal, a protection mechanism may be deployed by the transmitting station to defer any transmission by an interferer for a known period of time.

In the example of FIG. 1, an NDP may be setup between two or more wireless devices (e.g., user device(s) 120) in order to exchange data. In one embodiment, two or more NAN2 devices may utilize high throughput/very high throughput (HT/VHT) transmission rates. When using high rates, a check may be performed to determine if data transmission on a particular communication channel needs to be protected by control frames such as request to send/clear to send (RTS/CTS) or CTS-to-self. This protection may be needed in order to avoid legacy (e.g., non-HT) station interference with the data exchange between the two NAN2 devices. In a regular basic service set (BSS) AP infrastructure, the AP may take the task of detecting whether a protection is needed, and if so, the AP may advertise channel protection information in a beacon frame by using fields in an HT operation field: The fields may include an HT protection and Non-greenfield present bit, and one or more fields including Use_Protection in an Extended rate physical layer (ERP) element. The AP then may advertise the HT operation, each target beacon transmission time (TBTT) (e.g., around 100 ms), and the associated stations may obey the rules according to the IEEE 802.11 standard. However, with NAN2 devices, no AP nor beacon frames are used because, in the NAN2 protocol, there is no central coordination point (AP) which NAN2 devices can hear in every channel the NAN2 devices may select to use. In addition, NAN2 devices are not always in the same channel as in the BSS case, so the current information the NAN2 devices may have regarding the channel may not be accurate or up-to-date. Because of these reasons, the NAN2 devices may need to detect by themselves whether a protection mode is warranted, and periodically check if more up-to-date information may be obtained from other members of a multicast group.

In one embodiment, in order to detect if a protection mode is needed, a user device 120 may save to a database at least in part the following three fields per channel: HT Protection, Nongreenfield, and Use_protection per enabled channel (e.g., a channel that is enabled by regulatory rules of the station). Whenever a user device 120 switches into a new channel, it may detect if one of the aforementioned fields needs to be set by using rules from the IEEE 802.11 communication standards with regard to Non-ERP stations (see, e.g., 9.23.2 in IEEE 802.11 2012), and especially when a user device 120 identifies a beacon/probe response/probe request from overlapping BSS with supported rates elements. The supported rates may include only clause 16, 17 rates, and 9.23.2 in IEEE 802.11 2012 for HT protection in which the HT protection may be set according to the following examples.

In one embodiment, the HT Protection may be set to no protection when the user device 120 does not detect any non-HT station in a primary channel and in secondary channels (e.g., by receiving a beacon/probe request/probe response). In another embodiment, the HT Protection may be set to 20 MHz protection when the user device 120 does not detect any non-HT station in the primary channel and in the secondary channels (e.g., by receiving a beacon/probe request/probe response), and either the user device 120 itself or another peer user device in communication with the user device 120 is a 20 MHz only device (the user device 120 may know the capabilities of peer user devices from the NDP setup procedure discussed above). In yet another embodiment, HT Protection may be set to Non-HT mixed mode when the user device 120 detects a non-HT station (e.g., in the primary and secondary channels).

In one embodiment, the two or more of the user devices 120 may be in a NAN2 cluster where all devices are HT capable. In one embodiment, Nongreenfield Present may be set if a peer or the user device 120 itself does not support a GreenField preamble.

In one embodiment, when the HT Protection field is set to no protection mode or a 20 MHz protection mode, and the Nongreenfield HT station's Present field is equal to 0, no protection may be required because all HT stations in the channel may be capable of decoding HT-mixed format and HT-GreenField format transmissions.

In one embodiment, when the HT Protection field is equal to no protection mode or a 20 MHz protection mode, and the Nongreenfield HT station's Present field is equal to 1, HT transmissions that use the HT-GreenField format may be protected.

In one embodiment, a protection mode may be enabled or disabled based on one or more of the entries of the Use_Protection field, the HT Protection field, or the Non-GreenField field. The protection mode may indicate whether or not to communicate in a communication channel at a given time.

In one embodiment, whenever a user device 120 updates one of the above-referenced fields, the user device 120 may save the updated fields in a channel database with a current timestamp (e.g., via a timing synchronization function (TSF)) of the NAN2 cluster. The updates may allow for enabling or disabling of a protection mode based on the updated values.

In one embodiment, a NAN2 device may exchange multicast data with other peer devices in an NDC schedule, NMSG schedule, or DW time slots. Upon each such time slot, all NAN2 devices in a NAN2 data cluster may be available to exchange multicast data. In these time slots, the NAN2 devices may send a NAN2 management frame (NMF) which includes a Channel Protection Information Attribute with protection information and the timestamps for all channels for which they have information. A user device 120 receives an NMF, may compare the information per channel, and if the information in the NMF is more recent (with respect to the timestamp) then the user device 120 may update its database with the more recent protection fields.

In one embodiment, a user device 120 that switches into a channel may check its own database for the relevant channel and use that information to enable protection, by using rules from the IEEE 802.11 communication standards, with the aforementioned fields in the database. When working in the channel, if a user device 120 detects any change in one of the aforementioned fields based on the IEEE 802.11 communication standards, it may update the fields in its database and continue to work with the new protection configuration resulting from the change.

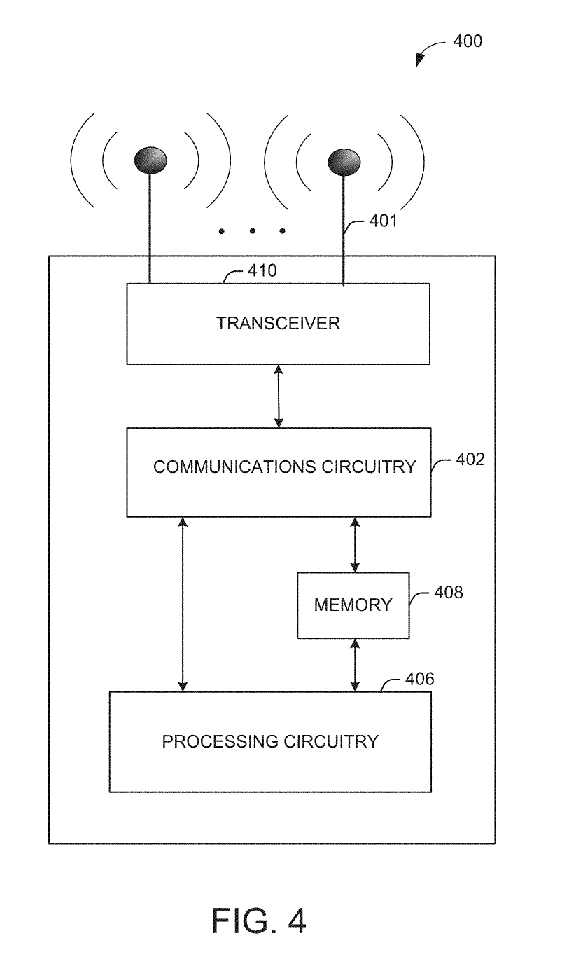

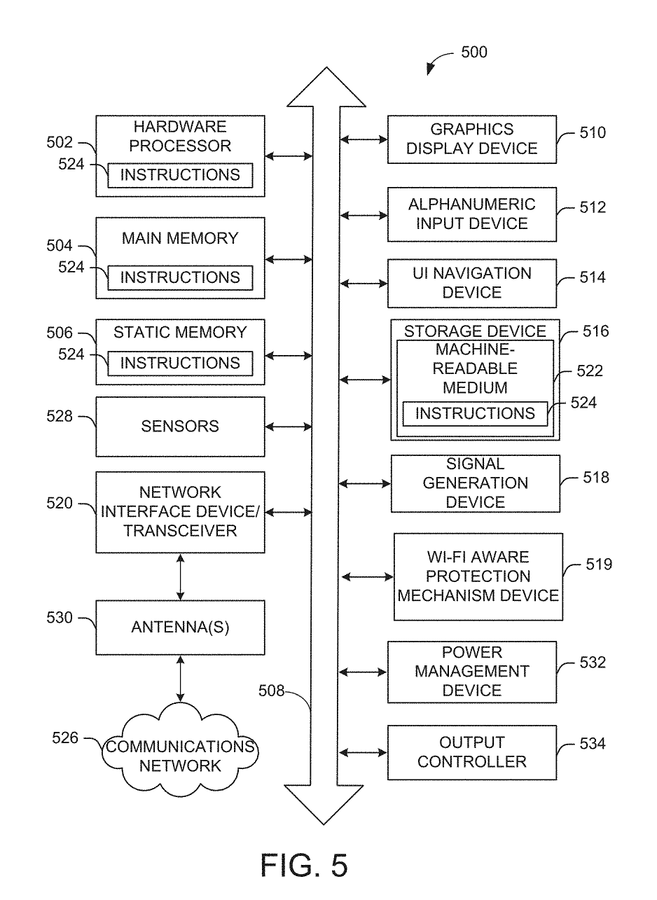

In some embodiments, the user devices 120 can include one or more computer systems similar to that of the functional diagram of FIG. 4 and/or the example machine/system of FIG. 5.

One or more illustrative user device(s) 120 may be operable by one or more user(s) 110. The user device(s) 120 (e.g., 122, 124, 126, or 128) may include any suitable processor-driven user device including, but not limited to, a desktop user device, a laptop user device, a server, a router, a switch, an access point, a smartphone, a tablet, a wearable wireless device (e.g., a bracelet, a watch, glasses, a ring, etc.), and so forth.

Any of the user devices 120 (e.g., 122, 124, 126, or 128) may be configured to communicate with each other and any other component of the wireless network 100 directly and/or via the one or more communications networks 130, wirelessly or wired.

Any of the communications networks 130 may include, but not be limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user devices 120 (e.g., 122, 124, 126, or 128) may include one or more communications antennas. Communications antennas may be any suitable type of antenna corresponding to the communications protocols used by the user device(s) 120. Some non-limiting examples of suitable communications antennas include Wi-Fi antennas, IEEE 802.11 family of standards compatible antennas, directional antennas, non-directional antennas, dipole antennas, folded dipole antennas, patch antennas, MIMO antennas, or the like. The communications antenna may be communicatively coupled to a radio component to transmit and/or receive signals, such as communications signals, to and/or from the user devices 120 (e.g., 122, 124, 126, or 128).

Any of the user devices 120 (e.g., 122, 124, 126, or 128) may include any suitable radio and/or transceiver for transmitting and/or receiving radio frequency (RF) signals in the bandwidth and/or channels corresponding to the communications protocols utilized by any of the user device(s) 120 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi Direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n), 5 GHz channels (e.g., 802.11n, 802.11ac), or 60 GHz channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

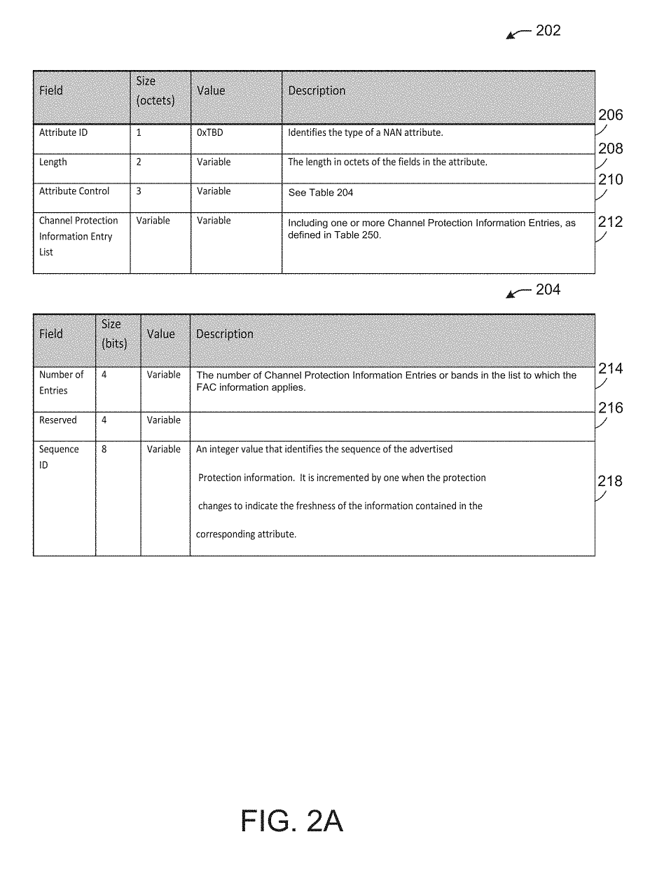

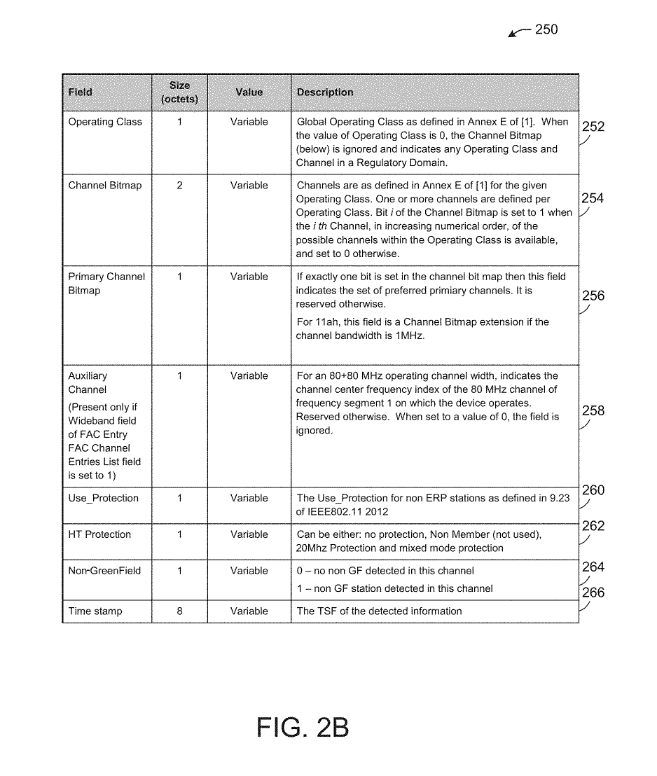

FIG. 2A depicts illustrative database tables that may be utilized by a Wi-Fi Aware protection mechanism system. In particular, illustrative database tables 202 and 204, including the aforementioned fields and additional information, may be sent in an NMF with channel protection information by a user device 120 in one embodiment.

In one embodiment, a client device (e.g., user device 120 in FIG. 1) may store information in one or more database tables 202, 204, and 250 (see FIG. 2B). Table 202 may include attribute information such as Attribute ID 206, Length 208, Attribute Control 210, and Channel Protection Information Entry List 212. The Attribute ID 206 may identify a type of NAN attribute. The Length 208 may identify how long an attribute may be. For example, the Length 208 may identify a number of octets in an attribute. Attribute Control 210 may refer to one or more fields as further discussed below in regard to table 204. Channel Protection Information Entry List 212 may include one or more channel protection information entries, such as those discussed below in regard to table 250. The fields in table 202 may include information regarding size (e.g., a number of octets), value, and description of the attribute information.

In one embodiment, table 204 may include attribute control information, such as the information referred to by the Attribute Control field 210 of table 202. Attribute control information may include fields such as a Number of Entries 214, a Reserved field 216, and a Sequence ID field 218. The Number of Entries field 214 may identify a number of channel protection information entries or bands in a list to which attribute control information may apply. The Sequence ID field 218 may refer to a value that increments each time the channel protection information is updated. For example, the Sequence ID field 218 may be an integer value that identifies the sequence of advertised channel protection information. Each field in table 204 may include a size (e.g., octets), a value, and a description.

FIG. 2B depicts an illustrative database table that may be utilized by a Wi-Fi Aware protection mechanism system.

In one embodiment, table 250 may include additional information, such as channel protection information. The fields of table 250 may include an Operating Class 252, a Channel Bitmap 254, a Primary Channel Bitmap 256, and Auxiliary Channel 258, a Use_Protection 260, an HT Protection 262, a Non-GreenField 264, and a time stamp field 266. The Operating Class field 252 may indicate a Global Operating Class as defined in the IEEE 802.11 standard. For example, when a value of Operating Class 252 is 0, the Channel Bitmap field 254 may be ignored, indicating any Operating Class 252 and channel in a regulatory domain. The Channel Bitmap field 254 may refer to channels as defined in the IEEE 802.11 standard for a given Operating Class 252. One or more channels may be defined by the Operating Class 252. For example, bit i of a Channel Bitmap 254 may be set to 1 when the ith channel, in increasing numerical order of the possible channels within the Operating Class 252, is available. Otherwise, the ith bit may be set to 0. The Primary Channel Bitmap 256 may refer to a set of preferred primary channels. For example, if exactly one bit is set in the Channel Bitmap 254, the Primary Channel Bitmap 256 may indicate the set of preferred primary channels, or otherwise may be reserved. In the IEEE 802.11ah standard, for example, the Primary Channel Bitmap field 256 may be a Channel Bitmap 254 extension if the channel bandwidth is 1 MHz. The Auxiliary Channel 258 may be a field that is present only if a Wideband field of an entry is set to 1. For an 80+80 MHz operating channel width, for example, the Auxiliary Channel 258 may indicate the channel center frequency index of the 80 MHz channel of frequency segment 1 on which a device operates. When the Auxiliary Channel 258 is set to a value of 0, the field may be ignored.

In one embodiment, table 250 may include channel protection information. Channel protection information entries, as referred to by the Channel Protection Information Entry List 212 of table 202 and by the Number of Entries 214 of table 204, may include the Use_Protection field 260, the HT Protection field 262, the Non-GreenField field 264, and the time stamp 266. The Use_Protection field 260 may refer to non-ERP stations as defined in Section 9.23 of the IEEE 802.11 standard. The HT Protection field 262 may refer to at least one of no protection, Non Member (not used), 20 MHz protection, or mixed mode protection. The Non-GreenField field 264 may indicate if any non-GreenField devices are present in a channel. A 0 value may indicate that no Non-GreenField devices are present in a channel, and where a 1 value may indicate that at least one GreenField device is detected in the channel. The time stamp 266 may indicate the timing information of detected information. For example, the time stamp 266 may indicate how recent given information in the tables 202, 204, and 250 may be. The time stamp 266 may indicate the time when one or more of the values in tables 202, 204, and 250 may have been stored. A NAN2 device may determine, based at least in part on the time stamp 266, whether information in a NAN2 frame is more recent than information stored on the NAN2 device or received from another NAN2 device.

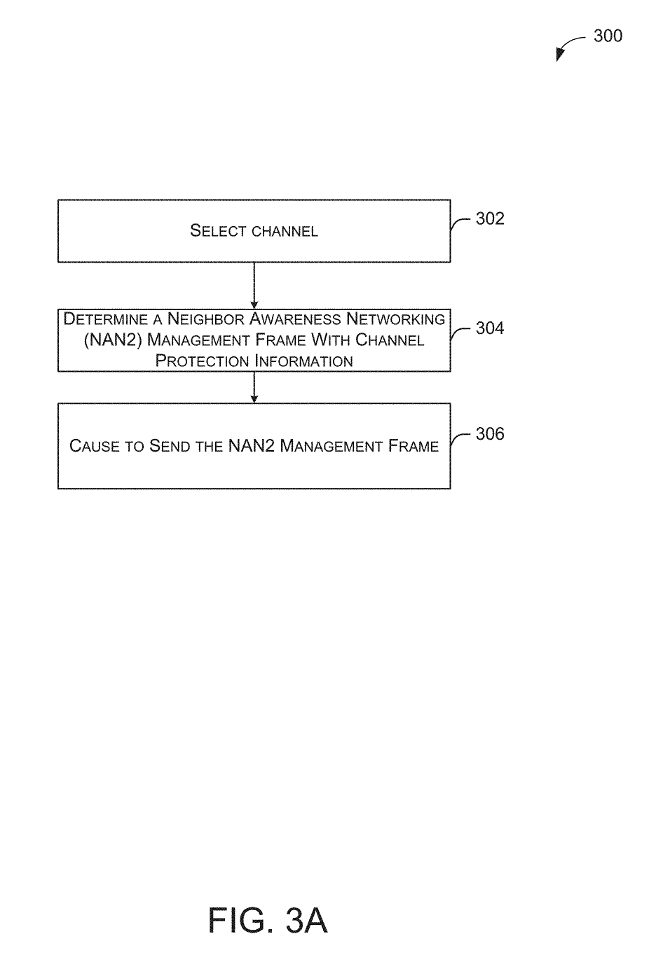

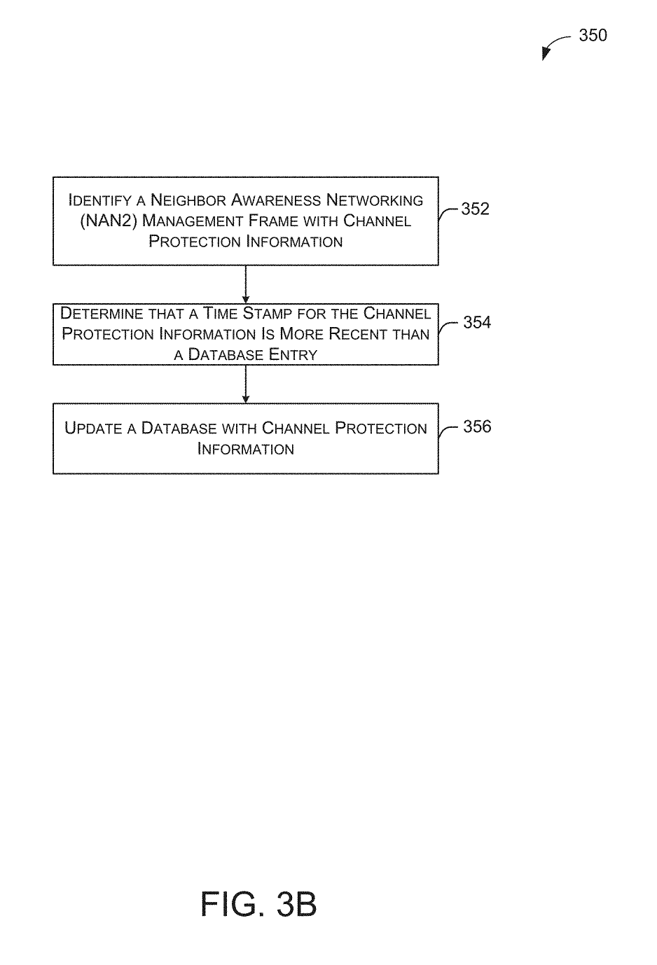

FIG. 3A depicts a flow diagram of an illustrative process 300 for Wi-Fi Aware protection mechanism system in accordance with one or more embodiments of the disclosure.

At block 302, a processor of a client device may select a channel from among one or more communication channels within a Neighbor Awareness Networking data cluster. A channel may be selected based on a protection mode indicated at least in part by the channel protection information of a NAN2 management frame. Channel protection information may indicate that a channel is not protected, or may indicate that a channel is protected and how. For example, HT Protection may be set to no protection when the client device does not detect any non-HT station in a primary channel and in secondary channels (e.g., by receiving a beacon/probe request/probe response). In one example, the HT Protection may be set to 20 MHz protection when the client device does not detect any non-HT station in the primary channel and in the secondary channels (e.g., by receiving a beacon/probe request/probe response), and either the client device itself or another peer user device in communication with the client device is a 20 MHz only device. In one example, HT Protection may be set to Non-HT mixed mode when the client device detects a non-HT station (e.g., in the primary and secondary channels). In one example, two or more client devices may be in a NAN2 cluster where all devices are HT capable. In one example, Nongreenfield Present may be set if a peer or the client device itself does not support a GreenField preamble. In one example, when the HT Protection field is set to no protection mode or a 20 MHz protection mode, and the Nongreenfield HT station's Present field is equal to 0, no protection may be required because all HT stations in the channel may be capable of decoding HT-mixed format and HT-GreenField format transmissions. In one example, when the HT Protection field is equal to no protection mode or a 20 MHz protection mode, and the Nongreenfield HT station's Present field is equal to 1, HT transmissions that use the HT-GreenField format may be protected.

At block 304, a processor of the client device may determine a NAN2 management frame. The NAN2 management frame may include channel attributes, information, and channel protection information as described above in FIGS. 2A and 2B. The channel protection information may be analyzed by the processor of the wireless device to determine a time and channel to send data to other wireless devices in an NDC. The processor of the client device may also enable or disable channel protection modes based on the channel protection information. The protection modes may indicate whether or not to send data in the selected communication channel at a given time based at least in part on the stored channel protection information for the selected channel.

At block 306, the processor of the client device may cause the wireless device to send a NAN2 management frame to other client devices in an NDC. The NAN2 management frame may include any updated channel protection information recorded on the client device. The NAN2 management frame may be sent according to the selected channel and/or according to a determined time to send the NAN2 management frame based at least in part on the channel protection information. The NAN2 management frame may also be sent based on whether or not a channel protection mode for the selected communication channel is indicated by the channel protection information for the selected channel.

FIG. 3B depicts a flow diagram of an illustrative process 350 for Wi-Fi Aware protection mechanism system in accordance with one or more embodiments of the disclosure.

At block 352, a processor of a client device may cause the client device to receive and may identify a NAN2 management frame. The NAN2 management frame may be received from another device in an NDC. The NAN2 management frame may include channel protection information and other channel attributes (e.g., tables 202 and 204 in FIG. 2A, and table 250 in FIG. 2B) for protecting data transmissions between the client device and one or more other client devices in the NDC without an AP. In one embodiment, the client device and the one or more other client devices may be NAN2 devices in the NDC. The channel protection information may represent data for a communication channel that may be stored on the client device.

At block 354, the processor of the client device may determine that a time stamp for the received channel protection information is more recent than a database entry for a communication channel associated with the NAN2 management frame. In one embodiment, the client device may enable or disable a protection mode based on the channel protection information. In one example, the processor for the client device may compare the time stamp for the received NAN2 management frame and its corresponding channel protection information to a time stamp in one or more database entries stored on the client device for the communication channel. If the time stamp of the received NAN2 management frame is more recent, then the client device may determine to update one or more of the database entries for the communication channel. This in effect maintains the latest protection information associated with each communication channel. That information may be used when determining to send a frame using that communication channel. A device may refrain from using that particular communication channel based on the protection modes found in the most recent time stamp entry.

At block 356, the processor of the wireless device may update a database with channel protection information. For example, if the time stamp of the identified channel protection information is more recent than the time stamp of stored channel protection information for the communication channel, then the identified channel protection information is more recent and may replace the stored channel protection information in the database.

FIG. 4 shows a functional diagram of an exemplary communication station 400 in accordance with some embodiments. In one embodiment, FIG. 4 illustrates a functional block diagram of a communication station that may be suitable for use as a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The transceiver 410 may be a device comprising both a transmitter and a receiver that are combined and share common circuitry (e.g., communication circuitry 402). The communication circuitry 402 may include amplifiers, filters, mixers, analog to digital and/or digital to analog converters. The transceiver 410 may transmit and receive analog or digital signals. The transceiver 410 may allow reception of signals during transmission periods. This mode is known as full-duplex, and may require the transmitter and receiver to operate on different frequencies to minimize interference between the transmitted signal and the received signal. The transceiver 410 may operate in a half-duplex mode, where the transceiver 410 may transmit or receive signals in one direction at a time. In some embodiments, the communications circuitry 402 and the processing circuitry 406 may be configured to perform operations detailed in FIGS. 3A and 3B.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device memory.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or a bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, the alphanumeric input device 512, and the UI navigation device 514 may be a touch screen display. The machine 500 may additionally include a storage device 516 (i.e., a drive unit), a signal generation device 518 (e.g., a speaker), a Wi-Fi Aware protection mechanism device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine-readable medium 522 on which is stored one or more sets of data structures or instructions 524 (e.g., software) embodying or being utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The Wi-Fi Aware protection mechanism device 519 may be configured to detect a condition in which it needs to protect its data transmissions. The Wi-Fi Aware protection mechanism device 519 may further send a multicast notification in the Discovery Window (DW), NDC schedule slot, or NMSG to the other peers in its NDC, which reflects the protection mode in each channel it has information about. The peers then will compare this information to what they have in their database and take the most recent information and use the information to enable/disable the protection mechanism and to select a communication channel and time to send information.

It is understood that the above are only a subset of what the Wi-Fi Aware protection mechanism device 519 may be configured to perform and that other functions included throughout this disclosure may also be performed by the Wi-Fi Aware protection mechanism device 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone Service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wireles sly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refer to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, a user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one-way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates a radio frequency identification (RFID) element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MCM), discrete multi-tone (DMT), Bluetooth®, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

According to example embodiments of the disclosure, there may be a client device. The client device may include memory and processing circuitry that may select a communication channel for communication with one or more other client devices. The processing circuitry may also determine a Neighbor Awareness Networking management frame comprising channel protection information, wherein the channel protection information indicates one or more protection modes of the channel. The processing circuitry may also cause to send, to one or more other client devices in the Neighbor Awareness Networking data cluster, the Neighbor Awareness Networking management frame with the channel protection information.

The implementations may include one or more of the following features. Selecting a communication channel may include configuring the processing circuitry to compare one or more channel information entries in a database based on their respective timestamp. Selecting a communication channel may include determine a channel information entry from the database having a most recent timestamp. Selecting a communication channel may include configuring the processing circuitry to select the communicating channel associated with the determined channel information entry. The channel protection information may include at least one of a use protection field, a high-throughput protection field, or a non-GreenField protection field. The use protection field may indicate a use protection for a non-Effective Radiated Power (non-ERP) device. The high-throughput protection field may indicate no protection, a non-member client device, 20 MHz protection, or a mixed protection mode. The non-GreenField protection field may indicate that there is a non-GreenField client device on the communication channel. The processing circuitry may also determine that the channel protection information is updated. The client device and the one or more other client devices may also be Neighbor Awareness Networking client devices. The device may also include a transceiver that may transmit and receive wireless signals. The device may also include one or more antennas coupled to the transceiver.

According to example embodiments of the disclosure, there may be a client device. The client device may include memory and processing circuitry that may identify a first Neighbor Awareness Networking management frame received from a first client device in a Neighbor Awareness Networking data cluster, wherein the Neighbor Awareness Networking frame comprises first channel protection information for a first communication channel. The processing circuitry may also determine that a time stamp of the first channel protection information is more recent than a database entry for the first communication channel. The processing circuitry may also update the database entry with the first channel protection information.

The implementations may include one or more of the following features. The first channel protection information may include at least one of a use protection field, a high-throughput protection field, or a non-GreenField protection field. The use protection field may indicate a use protection for a non-Effective Radiated Power (ERP) device. The high-throughput protection field may indicate no protection, a non-member client device, 20 MHz protection, or a mixed protection mode. The non-GreenField protection field may indicate that there is a non-GreenField client device on the first communication channel. The processing circuitry may also determine that a second database entry for a second communication channel has a most recent timestamp. The processing circuitry may also determine that the second communication channel is available based at least in part on the second database entry. The processing circuitry may also identify a third Neighbor Awareness Networking management frame that may include second channel protection information for a third communication channel. The processing circuitry may also determine that a timestamp for the third Neighbor Awareness Networking management frame is not more recent than one or more database entries for the third communication channel.

According to example embodiments of the disclosure, there may be a non-transitory computer-readable medium storing computer-executable instructions which, when executed by a processor, may cause the processor to perform operations including identifying a first Neighbor Awareness Networking management frame received from a first client device in a Neighbor Awareness Networking data cluster, wherein the Neighbor Awareness Networking frame comprises first channel protection information for a first communication channel. The operations may also include determining that a time stamp of the first channel protection information is more recent than a database entry for the first communication channel. The operations may also include updating the database entry with the first channel protection information.

The implementations may include one or more of the following features. The first channel protection information may include at least one of a use protection field, a high-throughput protection field, or a non-GreenField protection field. The use protection field may indicate a use protection for a non-Effective Radiated Power (ERP) device. The high-throughput protection field may indicate no protection, a non-member client device, 20 MHz protection, or a mixed protection mode. The non-GreenField protection field indicate that there is a non-GreenField client device on the first communication channel. The operations may also include determining that a second database entry for a second communication channel has a most recent timestamp. The operations may also include determining that the second communication channel is available based at least in part on the second database entry. The operations may further include identifying a third Neighbor Awareness Networking management frame that may include second channel protection information for a third communication channel. The operations may further include determining that a timestamp for the third Neighbor Awareness Networking management frame is not more recent than one or more database entries for the third communication channel.

According to example embodiments of the disclosure, there may be a non-transitory computer-readable medium storing computer-executable instructions which, when executed by a processor, may cause the processor to perform operations including selecting a communication channel for communication with one or more other client devices. The operations may include determining a Neighbor Awareness Networking management frame comprising channel protection information, wherein the channel protection information indicates one or more protection modes of the channel. The operations may also include causing to send, to one or more other client devices in the Neighbor Awareness Networking data cluster, the Neighbor Awareness Networking management frame with the channel protection information.

The implementations may include one or more of the following features. Selecting the communication channel may include comparing one or more channel information entries in a database based on their respective timestamp. Selecting a communication channel may include determining a channel information entry from the database having a most recent timestamp. Selecting the communication channel may also include selecting the communicating channel associated with the determined channel information entry. The channel protection information may include at least one of a use protection field, a high-throughput protection field, or a non-GreenField protection field. The use protection field may indicate a use protection for a non-Effective Radiated Power (non-ERP) device. The high-throughput protection field may indicate no protection, a non-member client device, 20 MHz protection, or a mixed protection mode. The non-GreenField protection field may indicate that there is a non-GreenField client device on the communication channel. The operations may also include determining that the channel protection information is updated. The client device and the one or more other client devices may also be Neighbor Awareness Networking client devices.

According to example embodiments of the disclosure, there may be a method. The method may include selecting, by one or more processors of a client device, a communication channel for communication with one or more other client devices. The method may also include determining, by the one or more processors, a Neighbor Awareness Networking management frame comprising channel protection information, wherein the channel protection information indicates one or more protection modes of the channel. The method may also include cause for sending, by the one or more processors, to one or more other client devices in the Neighbor Awareness Networking data cluster, the Neighbor Awareness Networking management frame with the channel protection information.

The implementations may include one or more of the following features. Selecting the communication channel may include comparing, by the one or more processors, one or more channel information entries in a database based on their respective timestamp. Selecting a communication channel may include determining, by the one or more processors, a channel information entry from the database having a most recent timestamp. Selecting the communication channel may also include selecting, by the one or more processors, the communicating channel associated with the determined channel information entry. The channel protection information may include at least one of a use protection field, a high-throughput protection field, or a non-GreenField protection field. The use protection field may indicate a use protection for a non-Effective Radiated Power (non-ERP) device. The high-throughput protection field may indicate no protection, a non-member client device, 20 MHz protection, or a mixed protection mode. The non-GreenField protection field may indicate that there is a non-GreenField client device on the communication channel. The may also include determining, by the one or more processors, that the channel protection information is updated. The client device and the one or more other client devices may also be Neighbor Awareness Networking client devices.

According to example embodiments of the disclosure, there may be a client device. The method may include identifying, by the one or more processors, a first Neighbor Awareness Networking management frame received from a first client device in a Neighbor Awareness Networking data cluster, wherein the Neighbor Awareness Networking frame comprises first channel protection information for a first communication channel. The method may also include determining, by the one or more processors, that a time stamp of the first channel protection information is more recent than a database entry for the first communication channel. The method may also update the database entry with the first channel protection information.

The implementations may include one or more of the following features. The first channel protection information may include at least one of a use protection field, a high-throughput protection field, or a non-GreenField protection field. The use protection field may indicate a use protection for a non-ERP device. The high-throughput protection field may indicate no protection, a non-member client device, 20 MHz protection, or a mixed protection mode. The non-GreenField protection field may indicate that there is a non-GreenField client device on the first communication channel. The method may also include determining, by the one or more processors, that a second database entry for a second communication channel has a most recent timestamp. The method may also include determining, by the one or more processors, that the second communication channel is available based at least in part on the second database entry. The method may also include identifying, by the one or more processors, a third Neighbor Awareness Networking management frame that may include second channel protection information for a third communication channel. The method may also include determining, by the one or more processors, that a timestamp for the third Neighbor Awareness Networking management frame is not more recent than one or more database entries for the third communication channel.

According to example embodiments of the disclosure, there may be an apparatus. The apparatus may include a means for selecting a communication channel for communication of a client device with one or more other client devices. The apparatus may also include means for determining a Neighbor Awareness Networking management frame comprising channel protection information, wherein the channel protection information indicates one or more protection modes of the channel. The apparatus may also include means for causing to send, to one or more other client devices in the Neighbor Awareness Networking data cluster, the Neighbor Awareness Networking management frame with the channel protection information.

The implementations may include one or more of the following features. The means for selecting the communication channel may include means for comparing one or more channel information entries in a database based on their respective timestamp. The means for selecting the communication channel may also include means for determining a channel information entry from the database having a most recent timestamp. The means for selecting the communication channel may also include means for selecting the communicating channel associated with the determined channel information entry. The channel protection information may include at least one of a use protection field, a high-throughput protection field, or a non-GreenField protection field. The use protection field may indicate a use protection for a non-ERP device. The high-throughput protection field may indicate no protection, a non-member client device, 20 MHz protection, or a mixed protection mode. The non-GreenField protection field may indicate that there is a non-GreenField client device on the communication channel. The apparatus may also include means for determining that the channel protection information is updated. The client device and the one or more other client devices may also be Neighbor Awareness Networking client devices.

According to example embodiments of the disclosure, there may be an apparatus. The apparatus may include a means for identifying a first Neighbor Awareness Networking management frame received from a first client device in a Neighbor Awareness Networking data cluster, wherein the Neighbor Awareness Networking frame comprises first channel protection information for a first communication channel. The apparatus may also include a means for determining that a time stamp of the first channel protection information is more recent than a database entry for the first communication channel. The apparatus may also include a means for updating the database entry with the first channel protection information.

The implementations may include one or more of the following features. The first channel protection information may include at least one of a use protection field, a high-throughput protection field, or a non-GreenField protection field. The use protection field may indicate a use protection for a non-ERP device. The high-throughput protection field may indicate no protection, a non-member client device, 20 MHz protection, or a mixed protection mode. The non-GreenField protection field may indicate that there is a non-GreenField client device on the first communication channel. The apparatus may also include means for determining that a second database entry for a second communication channel has a most recent timestamp. The apparatus may also include means for determining that the second communication channel is available based at least in part on the second database entry. The apparatus may also include means for identifying a third Neighbor Awareness Networking management frame that may include second channel protection information for a third communication channel. The apparatus may also include means for determining that a timestamp for the third Neighbor Awareness Networking management frame is not more recent than one or more database entries for the third communication channel.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product comprising a computer-readable storage medium, having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams and combinations of blocks in the block diagrams and flow diagrams can be implemented by special-purpose, hardware-based computer systems that perform the specified functions, elements, steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A client device, the client device comprising memory and processing circuitry configured to:
select a channel from one or more channels within a Neighbor Awareness Networking data cluster;
determine a Neighbor Awareness Networking management frame comprising channel protection information, wherein the channel protection information indicates one or more protection modes of the channel; and
cause to send, to one or more other client devices in the Neighbor Awareness Networking data cluster, the Neighbor Awareness Networking management frame with the channel protection information.

2. The client device of claim 1, further comprising configuring the processing circuitry to:
determine a channel information entry from a database having a most recent timestamp.

3. The client device of claim 2, wherein the channel protection information comprises at least one of a use protection field, a high-throughput protection field, or a non-GreenField protection field.

4. The client device of claim 3, wherein the use protection field indicates a use protection for a non-Effective Radiated Power (non-ERP) device.

5. The client device of claim 3, wherein the high-throughput protection field indicates no protection, a non-member client device, 20 MHz protection, or a mixed protection mode.

6. The client device of claim 3, wherein the non-GreenField protection field indicates that there is a non-GreenField client device on the channel.

7. The client device of claim 1, wherein the processing circuitry is further configured to determine that the channel protection information is updated.

8. The client device of claim 1, wherein the client device and the one or more other client devices are Neighbor Awareness Networking client devices.

9. The client device of claim 1, further comprising a transceiver configured to transmit and receive wireless signals.

10. The client device of claim 9, further comprising one or more antennas coupled to the transceiver.

11. A non-transitory computer-readable medium storing computer-executable instructions which, when executed by a processor, cause the processor to perform operations comprising:
identifying a first Neighbor Awareness Networking management frame received from a first client device in a Neighbor Awareness Networking data cluster, wherein the Neighbor Awareness Networking frame comprises first channel protection information for a first communication channel;
determining that a time stamp of the first channel protection information is more recent than a database entry for the first communication channel; and
updating the database entry with the first channel protection information.

12. The non-transitory computer-readable medium of claim 11, wherein the first channel protection information comprises at least one of a use protection field, a high-throughput protection field, or a non-GreenField protection field.

13. The non-transitory computer-readable medium of claim 12, wherein the use protection field indicates a use protection for a non-ERP device.

14. The non-transitory computer-readable medium of claim 12, wherein the high-throughput protection field indicates no protection, a non-member client device, 20 MHz protection, or a mixed protection mode.

15. The non-transitory computer-readable medium of claim 12, wherein the non-GreenField protection field indicates that there is a non-GreenField client device on the first communication channel.

16. The non-transitory computer-readable medium of claim 11, wherein the operations further comprise:
determining that a second database entry for a second communication channel has a most recent timestamp; and
determining that the second communication channel is available based at least in part on the second database entry.

17. The non-transitory computer-readable medium of claim 11, wherein the operations further comprise:
identifying a second Neighbor Awareness Networking management frame comprising second channel protection information for a third communication channel; and
determining that a timestamp for the second Neighbor Awareness Networking management frame is not more recent than one or more database entries for the third communication channel.

18. A method comprising:
selecting, by one or more processors of a client device, a channel from one or more channels within a Neighbor Awareness Networking data cluster;
determining, by the one or more processors, a Neighbor Awareness Networking management frame comprising channel protection information, wherein the channel protection information indicates one or more protection modes of the channel; and
causing to send, by the one or more processors, to one or more other client devices in the Neighbor Awareness Networking data cluster, the Neighbor Awareness Networking management frame with the channel protection information.

19. The method of claim 18, further comprising:
determining a channel information entry from a database having a most recent timestamp.

20. The method of claim 18, wherein the channel protection information comprises at least one of a use protection field, a high-throughput protection field, or a non-GreenField protection field.
